(19) United States
(12) Patent Application Publication
(10) Pub. No.: US 2023/0308584 A1
(43) Pub. Date: Sep. 28, 2023

(54) PRINT DEVICE MANAGEMENT APPARATUS AND PRINT DEVICE MANAGEMENT METHOD FOR SYSTEMS WITH DIFFERENT USAGE LOCATIONS

(71) Applicant: TOSHIBA TEC KABUSHIKI KAISHA, Tokyo (JP)

(72) Inventor: Youichi KUDO, Mishima Shizuoka (JP)

(21) Appl. No.: 17/700,901

(22) Filed: Mar. 22, 2022

(51) Int. Cl. H04N 1/34; G06F 3/12

(52) U.S. Cl. CPC H04N 1/344; H04N 1/346; G06F 3/1273; G06F 3/1238; G06F 3/1222

(57) ABSTRACT

According to one embodiment, a management apparatus manages a plurality of image forming devices, such as printers or multi-functional peripheral devices in different usage environments. The management apparatus includes a processor to acquire usage history information from each of the image forming devices and generates, based on the acquired usage history information, a bill including a total of usage charges for use of the image forming devices by a user group during a billing period. The management apparatus includes a communication interface to transmit the generated bill to a billing destination.

### FIELD

Embodiments described herein relate generally to a management apparatus for managing print devices across different usage environments or locations and a corresponding print device management method.

### BACKGROUND

In recent years, opportunities for performing remote work in a place other than an office environment, such as working at home, satellite offices, shared offices, or the like, is on the increase. In consideration of such a change in working styles, an environment in which a printer or other peripheral devices can be provided for workers even in places other than a single company office environment. However, when a printer or the like is used outside a company's office, it may be required to make a reservation for usage or a new connection each time a user wishes to use the device. In some environments, it may also be required for a user to perform a complicated procedure for using the device such as when use of the device requires the payment of a usage charge, division of associated expenses between different companies in a shared environment, or the like.

### BRIEF DESCRIPTION OF THE DRAWINGS

FIG. 1 is a diagram illustrating a configuration of an image forming system according to an embodiment.

FIG. 2 is a block diagram illustrating a hardware configuration of an image forming apparatus.

FIG. 3 is a block diagram illustrating a hardware configuration of a management apparatus.

FIG. 4 is a diagram illustrating an example of a usage environment table.

FIG. 5 is a diagram illustrating an example of a user information table.

FIG. 6 is a flowchart of an information registration process performed by a management apparatus.

FIG. 7 is a sequence diagram of a series of processes performed by an image forming system.

FIG. 8 is a flowchart of a bill generation process performed by a management apparatus.

### DETAILED DESCRIPTION

In general, according to one embodiment, a management apparatus for managing a plurality of image forming devices in different usage environments includes a processor and a communication interface. The processor is configured to: acquire usage history information from each of a plurality of image forming devices, and then generate, based on the acquired usage history information, a bill including a total of usage charges for use of the plurality of image forming devices by a user group during a billing period. The communication interface is configured to transmit the generated bill to a billing destination.

Hereinafter, a management apparatus and a management method of certain example embodiments will be described with reference to the drawings.

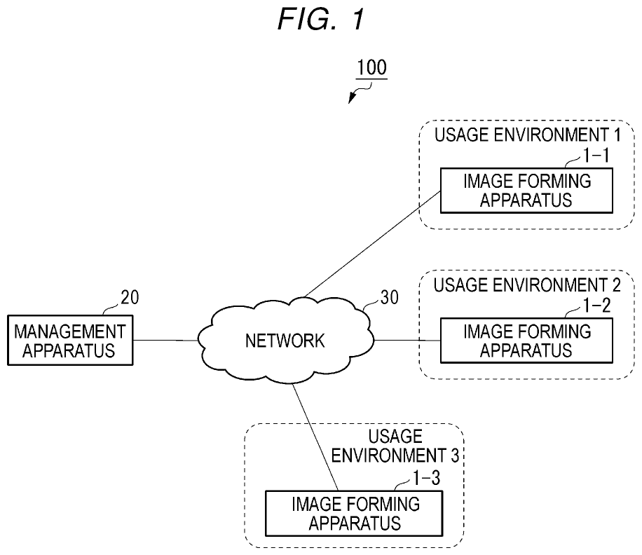

FIG. 1 is a diagram illustrating a configuration of an image forming system 100 in an embodiment. The image forming system 100 includes a management apparatus 20 and a plurality of image forming apparatuses (image forming apparatus 1-1, image forming apparatus 1-2, and image forming apparatus 1-3). The image forming system 100 is not limited to three image forming apparatuses, and, in general, any number of image forming apparatuses may be included. The image forming apparatuses 1-1 to 1-3 and the management apparatus 20 are connected to each other via a network 30. The network 30 may be a network configured in any manner permitting communication between the management apparatus 20 and the image forming apparatuses 1-1 to 1-3. For example, the network 30 can be a wireless local area network (LAN), the Internet, or the like.

The image forming apparatuses 1-1 to 1-3 are installed and used in different places. A place where the image forming apparatus is located can be a place other than an office of a company at which a user using the image forming apparatus is employed. For example, the places where the image forming apparatus can be used might be a home, a satellite office, a shared office, a school, or the like. In this manner, the image forming apparatuses 1-1 to 1-3 are installed in a place where the image forming apparatus can be used by a user who works at a place other than an office of a company by remote work.

In the example illustrated in FIG. 1, the image forming apparatus 1-1 is installed in a usage environment 1 (for example, a satellite office), the image forming apparatus 1-2 is installed in a usage environment 2 (for example, a shared office), and the image forming apparatus 1-3 is installed in a usage environment 3 (for example, a school). A plurality of image forming apparatuses may be installed in each of the usage environments.

Each image forming apparatus can be capable of executing a plurality of functions. For example, an image forming apparatus can execute a scanning function, a fax transmission function, a printing function, and a copying function. The scanning function, the FAX transmission function, the printing function, and the copying function that can be executed by an image forming apparatus are collectively referred to as a MFP (multi-functional peripheral) function or MFP functions in the following description. Each image forming apparatus transmits usage history information regarding usage of the MFP functions to the management apparatus 20. The usage history information includes, for example, information regarding the MFP functions that have been executed by the image forming apparatus and information indicating the number of times a MFP function has been executed during a period of time or during a series of processes. In this context, a series of processes can refer to the processes or MFP functions performed by an authenticated (logged-in user) using the image forming apparatus before the authenticated user logs out from the image forming apparatus (or otherwise the image forming system 100).

The management apparatus 20 manages each image forming apparatus connected thereto. The management apparatus 20 acquires the usage history information from each image forming apparatus. The management apparatus 20 generates, based on the acquired usage history information, a bill including a total of usage charges for the user or other entity. The management apparatus 20 transmits the generated bill to a billing destination. The management apparatus 20 can be an information processing apparatus such as a personal computer or the like.

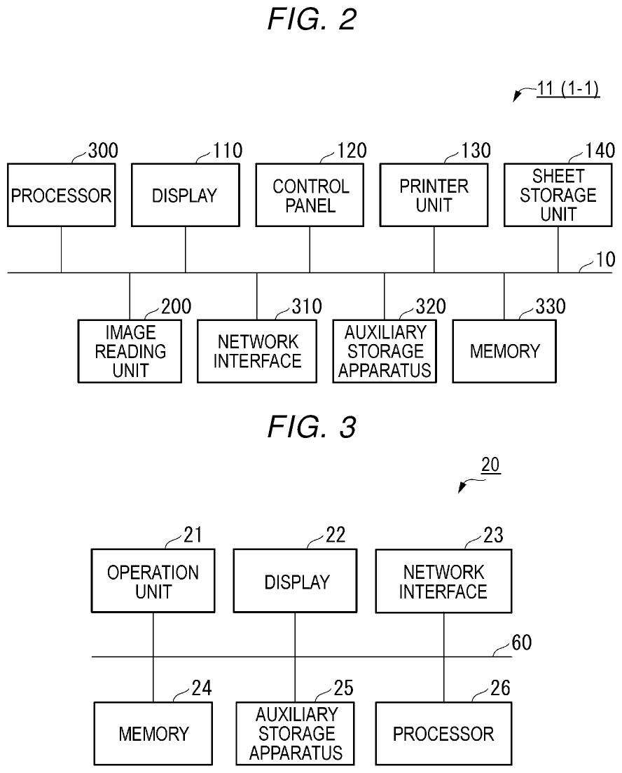

FIG. 2 is a block diagram illustrating a hardware configuration of an image forming apparatus 11 (corresponding to the image forming apparatus 1-1) in the present embodiment. The other image forming apparatuses 1-2 and 1-3 may likewise correspond in structure to the image forming apparatus 11, though, in general, image forming apparatus 11 is merely representative and certain elements may be omitted or added to an image forming apparatus incorporated into the image forming system 100.

The image forming apparatus 11 includes a display 110, a control panel 120, a printer unit 130, a sheet storage unit 140, an image reading apparatus 200, a processor 300, a network interface 310, an auxiliary storage apparatus 320, and a memory 330. These respective units are connected to each other such that data communication therebetween can be performed via a system bus 10.

The display 110 is an image display apparatus such as a liquid crystal display device, an organic EL display device, or the like. The display 110 displays various pieces of information regarding operation and status of the image forming apparatus 11. The display 110 may also receive a user input operation when a touch panel or the like is incorporated in the display 110. In such a case, the display 110 outputs a signal corresponding to the input operation performed by the user.

The control panel 120 includes a plurality of buttons. The control panel 120 receives a user input operation. The control panel 120 outputs a signal corresponding to the input operation performed by the user to the processor 300.

The printer unit 130 executes an image forming process for printing information on a sheet. The printer unit 130 can print on a sheet based on image information generated by the image reading apparatus 200 or, alternatively, image information received from an external device via a network communication path or the like. The printer unit 130 can be used for performance of a copying (copier) function and a printing (printer) function.

The sheet storage unit 140 stores sheets of paper to be by the printer unit 130.

The image reading apparatus 200 reads an image based on, for example, reflected intensity of light from a document placed on a document platen or otherwise scanned. The image reading apparatus 200 records the read image information in memory or the like. The recorded image information may be transmitted to another information processing apparatus via a network. The recorded image information may be reproduced (printed) on a sheet by the printer unit 130. The image reading apparatus 200 may be referred to as a document scanner in some instances.

The network interface 310 transmits and receives data to and from the management apparatus 20. The network interface 310 operates as a type of input interface and receives instructions and information transmitted from the management apparatus 20. The information transmitted from the management apparatus 20 can be, for example, an authentication result. The network interface 310 operates as a type of output interface and transmits data (for example, usage history information) to the management apparatus 20.

The auxiliary storage apparatus 320 is, for example, a hard disk drive or a solid-state drive (SSD). The auxiliary storage apparatus 320 stores various software programs, digital data, print jobs (print instructions), job logs, usage history information, and the like. A software program for implementing one or more of the functions of the image forming apparatus 11 can be stored in the auxiliary storage apparatus 320.

The memory 330 temporarily stores data to be used by the image forming apparatus 11. The memory 330 is, for example, a random access memory (RAM). The memory 330 may store digital data generated by the image reading apparatus 200. The memory 330 may temporarily store a print job, a job log, or usage history information.

The processor 300 can be a central processing unit (CPU), a graphics processing unit (GPU), or the like. The processor 300 controls functions of the image forming apparatus 11. For example, the processor 300 loads a software program stored in the auxiliary storage apparatus 320 onto the memory 330, and performs a process function by executing the software program. The processor 300 executes processing for providing various MFP functions (for example, a scanning function, a fax transmission function, a printing function, and a copying function) in response to an instruction input by a user at, or connected to, the image forming apparatus 11.

FIG. 3 is a block diagram illustrating a hardware configuration of the management apparatus 20 in the embodiment.

The management apparatus 20 includes an operation unit 21, a display 22, a network interface 23, a memory 24, an auxiliary storage apparatus 25, and a processor 26 connected to each other such that data communication therebetween can be performed via a system bus 60.

The operation unit 21 receives an input operation of a user (e.g., a system managing user). The operation unit 21 outputs a signal corresponding to the operation performed by the user to the processor 26.

The display 22 is an image display apparatus such as a liquid crystal display device, an organic EL display device, or the like. The display 22 displays various pieces of information related to operations of the management apparatus 20 or the image forming system 100. When the display 22 is integrated with a touch panel or the like, the display 22 may output a signal corresponding to an input operation to the processor 26.

The network interface 23 transmits and receives data to and from other (external) apparatuses. Here, an external apparatus is, for example, an image forming apparatus 11 or an information processing apparatus of a company to which a user belongs. The network interface 23 operates as a type of input interface, and receives data (for example, usage history information) or other information transmitted from the image forming apparatus 11 such as an authentication request for authenticating the image forming apparatus 11 or a particular user of the image forming apparatus 11. The network interface 23 operates as a type of output interface and, for example transmits an authentication result to the image forming apparatus 11 in response to an authentication request. For example, the network interface 23 transmits an error notification to the image forming apparatus 11 if the authentication is not successful.

The network interface 23 may also transmit bill data (billing data) to an information processing apparatus (a billing destination) of a company to which a user of the image forming apparatus 11 belongs. In this context, billing data can be a document indicating a usage charge due for use of various functions (e.g., MFP functions) of the image forming apparatus 11. The billing data may be aggregated by individual user, user groups (predetermined groups of individual users), or the like. The billing data may be referred to as an invoice in some contexts.

The memory 24 temporarily stores data. The memory 24 is, for example, a RAM. The memory 24 may temporarily store a packet to be transmitted via the network interface 23 or otherwise.

The auxiliary storage apparatus 25 is, for example, a hard disk or a solid-state drive (SSD), and stores various data such as a usage environment table and a user information table. The usage environment table is a table in which information about usage environments is registered. The user information table is a table in which information about individual users is registered.

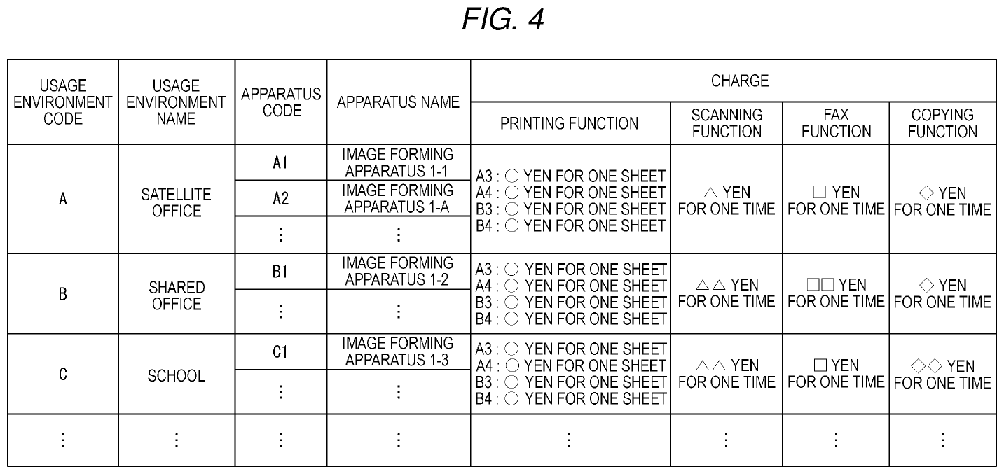

FIG. 4 is a diagram illustrating an example of the usage environment table in the present embodiment.

The usage environment table includes therein a plurality of records. Each record includes a usage environment code, a usage environment name, at least one apparatus code and corresponding apparatus name, and a charge list. The usage environment code is for uniquely identifying the usage environments registered in the management apparatus 20. The usage environment name can represent a particular name for a registered usage environment or may be a more generic type or style designation for the registered usage environment. For example, in FIG. 4, satellite office, shared office, and school are used as the usage environment names. The apparatus code is for uniquely identifying particular image forming apparatuses installed in a usage environment. The associated apparatus name can be an identifying name for the image forming apparatus.

The charge list indicates the charge to be incurred if a MFP function of an image forming apparatus is used. For example, in FIG. 4, a unit price for a printing function (by sheet size), a scanning function, a FAX function, and a copying function is registered for each usage environment code. Rent and installation costs generally vary depending on location. Therefore, the applicable charge to be applied may vary depending on the usage environment. The information in the usage environment table can be changed by an authorized user (e.g., a system managing user) or the like. FIG. 4 depicts charges as being set for each usage environment and, for printing, by sheet size/type. However, a charge list may also be established in consideration of the particular image forming apparatus utilized for performing the MFP function, print quality, color printing, etc.

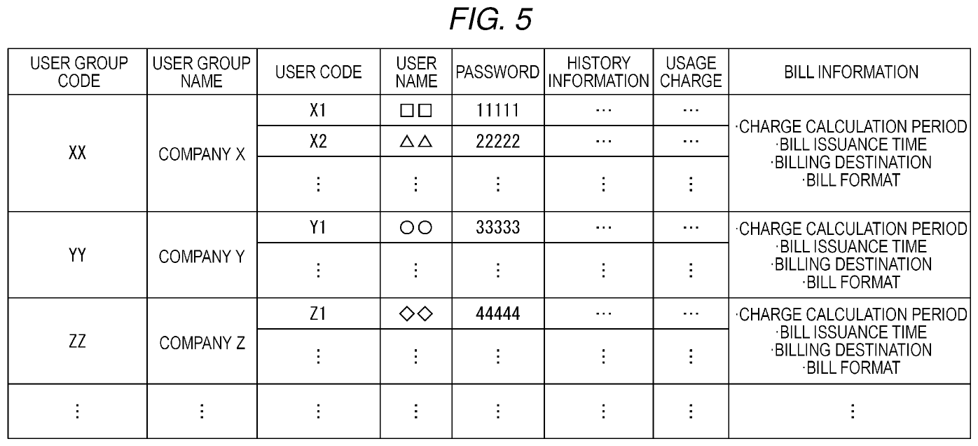

FIG. 5 is a diagram illustrating an example of the user information table in the present embodiment. The user information table includes a plurality of records. Each record includes a user group code, a user group name, at least one user code with corresponding user name, password, history information, usage charge, and billing information. The billing information in this example is set by user group code rather than individual user code. The user group code is for uniquely identifying a company (or other entity) to which user may belong. The user group name is an identifying name corresponding to the user code. Potential user groups are not limited to companies and any entity to which a user may belong may be the basis for establishing user group name and code. The user codes are for identifying the individual users of the image forming system 100. The user name is the name of corresponding to the registered user code. The passwords are information for authenticating individual users.

The history information includes a usage history of the managed image forming apparatuses of the image forming system 100 for each individual user. For example, as history information, a date and time of use, an MFP function used by the user, and the number of times the MFP function was used are registered for each user. As a result, a company (or other group) can track which individual user have used an image forming apparatus and also track how many times each user uses an image forming apparatus. The usage charge represents a cumulative charge incurred by the user according to the MFP functions used by the user. For example, the usage charge is calculated based on the history information and the usage environment table. The bill information is general information related to the billing. For example, the bill information indicates a charge calculation period (e.g., a billing period length), a bill issuance time, a billing destination, and a bill format.

The charge calculation period indicates the period of time for which usage should be totaled and billed (e.g., monthly, quarterly, yearly). For example, as the charge calculation period, a period from the beginning of the month to the end of the month and a period from ◯ to Δ days are registered. The bill issuance time indicates a timing when the bill is to be generated and sent to the user group. The billing destination indicates a destination (e.g., an address) to which the bill data is to be sent. For example, the billing destination can be an e-mail address. Information about the bill format indicates bill format preferences designated for each user group. For example, the bill format may indicate a preference a breaking down of usage charges by individual user or alternatively inclusion of only total user group charges.

Referring back to FIG. 3, the processor 26 can be a processor such as a CPU, a GPU, or the like. The processor 26 controls operations of the management apparatus 20. A specific processing of the processor 26 will be described as an example. The processor 26 acquires usage history information from each of the image forming apparatuses registered in the usage environment table, and then generates one or more bills based on the acquired usage history information.

The processor 26 is also capable of registering one or more usage groups to use a plurality of image forming apparatuses, and generating a bill for each usage group. The processor 26 is also capable of registering individual users for each usage group, and then generating bills for each usage group with a usage charge for each individual user in the usage group.

In general, the processor 26 generates a bill including all the usage charges within a period set for a usage group when the bill issuance time for the usage group arrives. The processor 26 furthermore can generate the bill for each usage group in a format set particularly for each usage group. The processor 26 generates the bills according to the charge list for each MFP function as established in the usage environment table.

The processor 26 determines, based on authentication information transmitted from an image forming apparatus, whether the image forming apparatus has been previously registered as an image forming apparatus in the image forming system 100.

The processor 26 also determines, based on the authentication information transmitted from the image forming apparatus, whether a user of the image forming apparatus is a previously registered user of the image forming system 100.

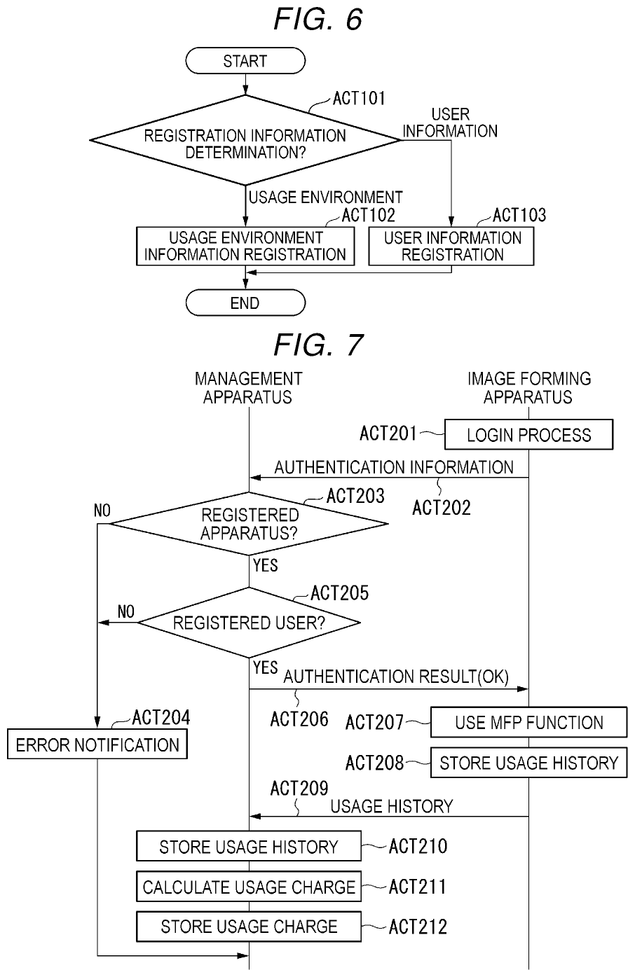

FIG. 6 is a flowchart of an information registration process performed by the management apparatus 20 in an embodiment. The process illustrated in FIG. 6 is executed when registration information is input to the management apparatus 20. Here, the registration information is information required to be registered before normal usage of the image forming system 100. Such information may be added to the usage environment table or the user information table as appropriate.

In a method for inputting the registration information to the management apparatus 20, a user of the management apparatus 20 may operate the operation unit 21 at the request of an individual user or an administrator of the user group to input the registration information. In some examples, the user of the management apparatus 20 may operate an external apparatus, such as a personal computer or the like or a mobile terminal, and input the registration information via the external apparatus. In some examples, a user of a user group may operate an external apparatus, such as the personal computer or the like or the mobile terminal, to input registration information to management apparatus by a grant of authority or permission provided by a user of the management apparatus 20.

In the process of FIG. 6, the processor 26 checks whether received information is an input of registration information (ACT 101). The processor 26 checks at this point whether the registration information is registration information for a usage environment or registration information for a user (user information). If the input registration information is for a usage environment, the processor 26 registers usage environment information in the usage environment table (ACT 102). For example, an image forming apparatus 1-A (see FIG. 4) can be registered for a usage environment 1 (e.g., a satellite office) in the usage environment table.

When the new image forming apparatus 1-A has been installed in the usage environment 1, the user of the management apparatus 20 operates the management apparatus 20 and appropriately registers “image forming apparatus 1-A” in the usage environment table. When a new image forming apparatus (e.g., image forming apparatus 1-A) is registered, the processor 26 issues a new apparatus code (for example, “A2”) for identifying the newly registered apparatus. After that, the processor 26 registers the apparatus code “A2” in association with the “image forming apparatus 1-A” apparatus name. The other information for the newly registered apparatus may also be entered or updated as this time in the table as necessary.

When registering a new usage environment in the usage environment table, the user of the management apparatus 20 operates the management apparatus 20 to add a new record to the usage environment table. The user of the management apparatus 20 registers a name for the new usage environment, and the processor 26 issues a new usage environment code. The additional usage environment information can be added for the newly registered usage environment in the usage environment table as appropriate. Likewise, one or more image forming apparatuses 11 may be registered in association with the newly registered usage environment at this time or subsequently.

In the process of ACT 101, if the input registration information is user registration information (user information), the processor 26 registers the user information in the user information table (ACT 103). Examples of user information include user group information, individual user information, and billing information. For example, if the user information is user group information (for example, a company Z), individual user information (for example, ⋄⋄), and associated billing information, which is being newly registered, this information is registered.

For example, when registering user group information (for example, the company Z), the user of the management apparatus 20 adds a new record to the user information table. The user of the management apparatus 20 thus registers “company Z” as a new item in the user group name records. When a new user group name is added, the processor 26 issues a user group code (for example, “ZZ”) for identifying the newly registered user group.

Next, when registering user information (for example, ⋄⋄) as new individual user information, the user of the management apparatus 2 operates the management apparatus 2 and registers “⋄⋄” as a new user name associated with “the company Z” in the user information table. The processor 26 issues a user code (for example, “Z1”) for identifying this newly registered user.

Next, when registering the necessary billing information (“bill information”), the user of the management apparatus 2 operates the management apparatus 2 and registers the billing information associated with “company Z” in the user information table.

FIG. 7 is a sequence diagram illustrating a flow of processes performed in the image forming system 100 in the present embodiment.

A user of the image forming apparatus 11 perform a login process (ACT 201). Examples of a login processing method include an authentication method performed by inputting a user name and a password and an authentication method performed by using an access card, but, in general, any authentication method may be used. Here, the authentication method using a user name and password will be described as an example.

The user of the image forming apparatus 1 operates the control panel 120 and inputs a user name and a password. The processor 300 generates authentication information, including the input user name and password, along with a usage environment code and an apparatus code. The usage environment code and the apparatus code may be provided by the management apparatus 20 to or for the image forming apparatus 11 in some examples. The processor 300 transmits the generated authentication information to the management apparatus 20 (ACT 202).

The network interface 23 receives the authentication information transmitted from the image forming apparatus 11. The network interface 23 provides the received authentication information to the processor 26. The processor 26 determines, based on the authentication information, whether or not the image forming apparatus 11 is a previously registered apparatus (ACT 203).

The processor 26 refers to the usage environment code and the apparatus code stored in the usage environment table, and determines whether the combination of the usage environment code and the apparatus code is present. If there is the combination present, the processor 26 determines that the image forming apparatus 11 is a previously registered apparatus. On the other hand, if the combination of the usage environment code and the apparatus code is not present in the usage environment table, the processor 26 determines that the image forming apparatus 11 is not a previously registered apparatus.

If the image forming apparatus 11 is not a registered apparatus (ACT 203: NO), the processor 26 notifies the image forming apparatus 1, via the network interface 23, of an error indicating that the authentication cannot be performed. The image forming apparatus 1 displays an error notification on the display 110.

If the image forming apparatus 11 is a registered apparatus (ACT 203: YES), the processor 26 next determines, based on the authentication information, whether or not the user is a registered user (ACT 205). The processor 26 refers to the user names and the passwords in the user information table, and determines whether the user name and the password provided in the authentication information has been registered in the user information table.

If a user name and its corresponding password in the user information table matches the user name and the password in the authentication information, the processor 26 determines that the user of the image forming apparatus 11 is a registered user. On the other hand, if the user name and its corresponding password in the user information table do not match the user name and the password in the authentication information, the processor 26 determines that the user of the image forming apparatus 11 is not a registered user.

If the user of the image forming apparatus 11 is not a registered user (ACT 205: NO), the processor 26 notifies the image forming apparatus 11, via the network interface 23, of an error indicating that the authentication cannot be performed. The image forming apparatus 1 displays an error notification on the display 110.

If the user is a registered user (ACT 205: YES), the processor 26 transmits an authentication result to the image forming apparatus 11 indicating that the authentication was successful.

The network interface 310 of an authenticated image forming apparatus 11 receives a successful authentication result from the management apparatus 20. The processor 300 permits the now-authenticated user to use the MFP functions of the image forming apparatus 11. Next, the user uses a MFP function of the image forming apparatus 11 (ACT 207).

Once the usage of the MFP function of the user is completed, the processor 300 stores information for a usage history for the user in the auxiliary storage apparatus 320 (ACT 208). The usage history includes, for example, the number and types of MFP functions used by user during the authenticated session. The usage history may be cumulative of all authenticated sessions of the user or time period specific. The completion of the usage by a user may be determined, for example, based on a log-out of the user. The processor 300 controls the network interface 310, and transmits the usage history (or a portion thereof) to the management apparatus 20 (ACT 209).

The network interface 23 of the management apparatus 20 receives the usage history transmitted from the image forming apparatus 11. The processor 26 registers the received usage history (or portion thereof) in the user information table (ACT 210). For example, the processor 26 registers the usage history as an item of history information in the user information table in the record associated with the user specified by the authentication information used for the authentication of the user.

After the usage history is registered in the user information table, the processor 26 calculates a usage charge based on the usage history and the specified charges (charge list) in the usage environment table for the image forming apparatus 11 or usage environment (ACT 211). For example, if the user uses the scanning function one time and the fax function one time in “satellite office” (usage environment code “A”) on the image forming apparatus 1-1 w, the processor 26 calculates “Δ+□” yen as the usage charge. The processor 26 registers the calculated usage charge and period information (e.g., date and time information) as an item of information in the “usage charge” column (ACT 212).

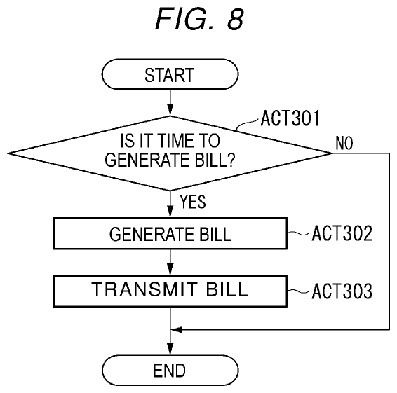

FIG. 8 is a flowchart of a bill generation process performed by the management apparatus 20 in the present embodiment.

The processor 26 refers to the bill information in the user information table and determines whether or not there is a user group (hereinafter referred to as a “billing target group”) for which a bill generation time has arrived (ACT 301). If there is no billing target group (ACT 301: NO), the management apparatus 2 ends the bill generation process.

On the other hand, if there is the billing target group (ACT 301: YES), the processor 26 generates a bill for the billing target group (ACT 302). Specifically, the processor 26 refers to the user information table and acquires usage charge information corresponding to billing period of the billing target group. Next, the processor 26 calculates total usage charges during the billing period. Next, the processor 26 generates a bill according to a bill format including the usage charges for the relevant billing period.

If the bill format specifies to include the usage charges broken out for each user in the relevant user group, the processor 26 generates a bill including such information. The processor 26 then controls the network interface 23 to transmit the generated bill data to a billing destination of the billing target group (ACT 303).

In the image forming system 100 configured as described above, the management apparatus 20 acquires usage history information from each of the registered image forming apparatuses 11 and generates a bill based on the acquired usage history information for each image forming apparatus. The management apparatus 20 transmits the generated bill data to the billing destination. Accordingly, the users of the image forming apparatus 11 registered in the image forming system 100 can eliminate the complicated procedures for individual payments and/or linking of usage to particular expense accounts that might otherwise be necessary. Therefore, the image forming apparatus 11 can be more easily used by a variety of users in different usage environments.

A modification of the above example will be described.

If a condition for discounting the usage charge is satisfied or otherwise a discount is available, the processor 26 may be configured to generate a bill for each usage group in accordance with the condition for discounting of the usage charge or available discount. In the configuration as described above, the management apparatus 20 stores a discount table or the like in which a particular discount amount and an associated condition for receiving the discount amount is stored. For example, the condition may be based on the number of registered people in a usage group, the number of times one particular type of MFP function is used, or a usage frequency of a particular image forming apparatus 11. When the management apparatus 20 discounts the usage charge based on the discount table information, the processor 26 generates a bill reflecting the discount amount when the associated condition is satisfied.

Some functions of the image forming apparatus 11 and the management apparatus 20 may be implemented by a general-purpose computer. In such case, a program for implementing the described functions of these apparatuses can be recorded in a non-transitory, computer-readable recording medium. Such a program may be subsequently read by a computer system and executed for implementing the various functions.

While certain embodiments have been described, these embodiments have been presented by way of example only, and are not intended to limit the scope of the inventions. Indeed, the novel embodiments described herein may be embodied in a variety of other forms: furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A management apparatus for managing a plurality of image forming devices in different usage environments, the management apparatus comprising:
a processor configured to:
acquire usage history information from each of a plurality of image forming devices in different usage environments, and
generate, based on the acquired usage history information and usage environment specific billing rates for each of the different usage environments, a bill including a total of usage charges for use of the plurality of image forming devices by a user group during a billing period; and
a communication interface configured to transmit the generated bill to a billing destination.

2. The management apparatus according to claim 1, wherein
a plurality of user groups are registered to use the plurality of image forming devices, and
the processor is configured to generate a separate bill for each of the plurality of user groups.

3. The management apparatus according to claim 2, wherein
each user group comprises one or more individual users,
the usage history includes individual user usage information, and
the bill for at least one of the plurality of user groups includes individual user usage charges based on the individual user usage information.

4. The management apparatus according to claim 1, wherein the processor is configured to automatically generate the bill when a bill issuance time for the user group arrives.

5. The management apparatus according to claim 1, wherein the processor is configured to calculate the total of usage charges based on conditional discount information.

6. The management apparatus according to claim 1, wherein processor is configured to:
perform a device authentication process based on authentication information transmitted from an image forming device, and
transmit, via the communication interface, an error notification to the image forming device if the authentication process is unsuccessful.

7. The management apparatus according to claim 6, wherein the processor is configured to:
perform a user authentication process based on the authentication information from the image forming device, and
transmit, via the communication interface, a user authentication fail error notification if the user authentication process is unsuccessful.

8. The management apparatus according to claim 7, wherein
the usage history information indicates particular functions performed by a user with the image forming device, and
the processor is configured to calculate the total of usage charges according to a charge preset for each particular function of the image forming device according to usage environment of the image forming device.

9. The management apparatus according to claim 1, wherein the processor is configured to:
perform a user authentication process based on authentication information transmitted from the image forming device, and
transmit, via the communication interface, a user authentication fail error notification if the user authentication process is unsuccessful.

10. The management apparatus according to claim 1, wherein the processor is configured to generate the bill in a format preset for the user group.

11. An image forming system, comprising:
a first printer at a first usage location;
a second printer at a second usage location;
a management apparatus connected to the first printer and the second printer via a network, the management apparatus including:
a processor configured to:
acquire usage history information from each of the first and second printers, and
generate, based on the acquired usage history information and usage environment specific billing rates for the first usage location and the second usage location, a bill including a total of usage charges for use of the first and second printers by a user group during a billing period; and
a communication interface configured to transmit the generated bill to a billing destination.

12. The image forming system according to claim 11, wherein the management apparatus further includes:
a storage device storing:
a usage environment table including registered information of the first and second printers, and
a user information table including registered information for a plurality of user groups permitted to use at least one of the first and second printers.

13. The image forming system according to claim 11, wherein the billing destination is an email address.

14. A method for a management apparatus managing a plurality of image forming devices at a plurality of locations, the method comprising:
acquiring usage history information from each of a plurality of image forming devices in different usage environments, and
generating, based on the acquired usage history information and usage environment specific billing rates for each of the different usage environments, a bill including a total of usage charges for use of the plurality of image forming devices by a user group during a billing period; and
transmitting the generated bill to a billing destination via a communication interface.

15. The method according to claim 14, wherein
a plurality of user groups are registered to use the plurality of image forming devices, and
the method further comprises:
generating a separate bill for each of the plurality of user groups.

16. The method according to claim 15, wherein
each user group comprises one or more individual users,
the usage history includes individual user usage information, and
the bill for at least one of the plurality of user groups includes individual user usage charges based on the individual user usage information.

17. The method according to claim 14, wherein the total of usage charges is calculated based on conditional discount information.

18. The method according to claim 14, further comprising:
performing a device authentication process based on authentication information transmitted from an image forming device, and
transmitting, via the communication interface, an error notification to the image forming device if the authentication process is unsuccessful.

19. The method according to claim 18, further comprising:
performing a user authentication process based on the authentication information from the image forming device, and
transmitting, via the communication interface, a user authentication fail error notification if the user authentication process is unsuccessful.

20. The method according to claim 14, further comprising:
performing a user authentication process based on authentication information transmitted from the image forming device, and
transmitting, via the communication interface, a user authentication fail error notification if the user authentication process is unsuccessful.
